(19) United States
(12) Patent Application Publication
(10) Pub. No.: US 2023/0116006 A1
(43) Pub. Date: Apr. 13, 2023

(54) HYDROGEN TRANSPORT AND STORAGE SYSTEM

(71) Applicant: Plug Power Inc., Latham, NY (US)

(72) Inventors: Alfonso CIOFFI, Albany, NY (US); Philippe BOISVERT, Albany, NY (US); Jessica KLOPFENSTEIN, Albany, NY (US); Zachary SEAVER, Albany, NY (US)

(73) Assignee: Plug Power Inc., Latham, NY (US)

(21) Appl. No.: 17/936,168

(22) Filed: Sep. 28, 2022

Related U.S. Application Data
(60) Provisional application No. 63/261,738, filed on Sep. 28, 2021.

(51) Int. Cl. F17C 9/00; H01M 8/04111; H01M 8/04082; H01M 8/04746; H01M 16/00; B60L 50/71; B60P 3/22

(52) U.S. Cl. CPC F17C 9/00; B60L 50/71; B60P 3/22; H01M 8/04111; H01M 8/04201; H01M 8/04753; H01M 8/04776; H01M 16/006; F17C 2201/054; F17C 2221/012; F17C 2221/033; F17C 2223/033; F17C 2227/0135; F17C 2227/0157; F17C 2250/03; F17C 2265/061; F17C 2270/0171; F17C 2270/0184; H01M 2220/20; H01M 2250/20

(57) ABSTRACT

A mobile hydrogen fueling system for use in fueling mobile hydrogen vehicles includes: a towing vehicle with a hydrogen powered fuel cell that powers the towing vehicle, and a trailer. The trailer includes a hydrogen storage tank, a hydrogen fuel transport device such as a gas compressor or a liquid pump, and a dispenser attached to the hydrogen tank that dispenses hydrogen to a receiving hydrogen tank. A controller regulates the hydrogen fuel transport device and thus the flow of hydrogen that the dispenser dispenses.

### CROSS-REFERENCE TO RELATED APPLICATIONS

The present application claims priority to U.S. Provisional Application No. 63/261,738 filed on Sep. 28, 2021, which is incorporated herein by reference in its entirety.

### TECHNICAL FIELD

The present invention relates, generally, to methods and systems for transporting and storing hydrogen, and more particularly, to systems and methods for transporting hydrogen and fueling hydrogen vehicles.

### BACKGROUND OF THE INVENTION

Many ports, warehouses and other industrial facilities are contributors to poor air quality due to the use of cargo handling equipment. Fleets of yard tractors, rubber tire gantry cranes, top loaders, forklifts, drayage trucks, locomotives, harbor craft, etc., spew voluminous quantities of criteria pollutants.

A conversion of such industrial vehicles to a zero-emission technology would provide benefits in air quality to surrounding areas. Battery electric alternatives have been deployed in several demonstration and pilot projects and have been determined to fall short of operational requirements of port terminal operators in areas such as payload capacity, recharge time, recharge method, and charging infrastructure cost and complexity at scale. Fuel cell electric vehicles (FCEV) are intrinsically very well suited to port cargo operations as their characteristics are very similar to that of diesel internal combustion engine (ICE) vehicles including: ample torque and payload capacity, fueling times on an order of minutes, consistent operation in all extremes of weather, long range and running times between fills, and such vehicles may be fueled similarly to an ICE vehicle.

Port operations today employ mobile diesel tanker trucks to provide fuel to vehicles that either, (i) cannot physically travel to a fueling station or, (ii) are fueled in place for operational efficiency reasons. Yard tractors, RTGs, locomotives, and harbor craft are examples of cargo vehicles that are fueled via a mobile diesel tanker truck. Gaseous hydrogen trailers of many types are readily available, but they all require a utility connection and are required to remain in a fixed location while dispensing. Such connection to utilities necessitates local permitting and certification from several local authorities having jurisdiction, such as building codes and fire departments. Further, the connection to such utilities minimizes the mobility of such tankers.

Fleet operators that may otherwise adopt a plan of trial for Fuel Cell Electric Vehicles, such as bus transit agencies, may be discouraged by a high cost of deploying a permanent hydrogen fueling station just to trial a few vehicles (e.g., buses). Such permanent hydrogen fueling stations may require a utility connection and permitting by local authorities having jurisdiction, as indicated above. Existing gas trailers for fleet refueling thus present the same barriers to adoption as experienced by port operators described above.

Thus, a need exists for systems and methods for hydrogen fueling of industrial and fleet vehicles that integrate with existing fleet, port and industrial processes.

### SUMMARY

The present invention provides, in a first aspect, a mobile hydrogen fueling system for use in fueling mobile hydrogen vehicles which includes a towing vehicle with a hydrogen powered fuel cell that powers the towing vehicle, and a trailer. The trailer includes a hydrogen storage tank, a hydrogen fuel transport device such as a gas compressor or a liquid pump, and a dispenser attached to the hydrogen tank that dispenses hydrogen to a receiving hydrogen tank. A controller regulates the hydrogen fuel transport device and thus the flow of hydrogen that the dispenser dispenses.

The present invention provides, in a second aspect, a method for refueling hydrogen vehicles with a trailer that has a hydrogen storage tank and a dispenser such that the hydrogen storage tank and dispenser are capable of filling hydrogen tanks with hydrogen. A towing vehicle transports the trailer to a location to refuel hydrogen vehicles, such as a hydrogen station or a typical gas station. The trailer and the towing vehicle do not require an electrical grid connection as the towing vehicle and trailer can supply the power necessary to dispense the hydrogen using the towing vehicle and/or trailer’s own power supply.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter which is regarded as the invention is particularly pointed out and distinctly claimed in the claims at the conclusion of the specification. The foregoing and other features and advantages of the invention will be readily understood from the following detailed description of the preferred embodiments taken in conjunction with the accompanying drawings in which:

FIG. 1 is a side cross-sectional view/diagram of a mobile hydrogen fueling system in accordance with the invention.

### DETAILED DESCRIPTION OF THE INVENTION

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

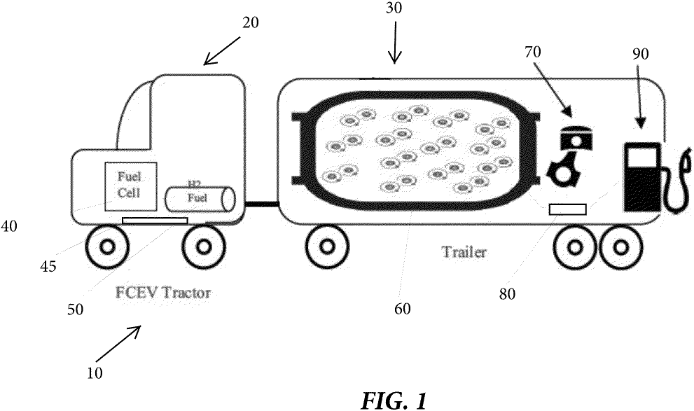

Thus, all the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In accordance with the principals of the present invention, systems and methods for transporting, storing and dispensing hydrogen to vehicles are provided. In an exemplary embodiment depicted in FIG. 1, a mobile hydrogen fueling system 10 may include a tractor 20 and a trailer 30.

Tractor 20 may be a fuel cell electric vehicle having a fuel cell 40 and a hydrogen tank 50 for holding liquid or gaseous hydrogen coupled thereto for supplying such a fuel cell during operation of the vehicle. Tractor 20 may have an electric power train 45 electrically coupled to fuel cell 40 such that power train 45 may be supplied with electricity appropriate to power such power train to drive the axles and/or wheels, along with associated components of tractor 20, to provide movement thereto. Fuel cell 40 may also be coupled to an inverter to provide suitable electricity to devices on a connected trailer (e.g., trailer 30). An energy storage device (e.g., a battery) may also be utilized on tractor 20 between fuel cell 40 and the drive train (e.g., power train 45) and/or any electrically consuming devices of the trailer (e.g., trailer 30), such that any loads of the power train (e.g., power train 45) and devices may be balanced, for example.

Trailer 30 may include a hydrogen storage tank or vessel 60, a hydrogen fuel transport device 70, a controller 80 and a dispenser 90. Hydrogen fuel transport device may be a gas compressor or liquid pump, for example. Devices on the trailer may be powered by an electricity source (e.g., fuel cell 40) supplied by tractor 20. For example, hydrogen fuel transport device 70, a controller 80 and a dispenser 90 may be electrically connected to fuel cell 40 of tractor 20.

The tractor and trailer combination (e.g., tractor 20 and trailer 30) may be of any size, but the tractor (e.g., tractor 20) must be equipped with (a) enough hauling power (e.g., via fuel cell 40) to transport the trailer with a full load (e.g., in vessel 60) of hydrogen and (b) with enough power (e.g., via fuel cell 40 or a supplemental fuel cell in tractor 30) to operate any needed controls and devices of the trailer, such as a compressor/pump (e.g., fuel transport device 70) and dispenser/controls (e.g., controller 80 and dispenser 90).

In an example, system 10 may be operated in a driving mode where fuel cell 40 of tractor 20 may provide suitable power to an electric power train (e.g., power train 45) such that tractor 20 and trailer 30 may perform mobility functions expected of any class of truck. Hydrogen fuel for the fuel cell (e.g., fuel cell 40) is provided by hydrogen fuel tank 50 of tractor 20. Alternatively, vessel 60 of trailer 30 may be coupled to the tractor hydrogen fuel tank (e.g., fuel tank 50) to provide additional hydrogen fuel to the fuel cell (e.g., fuel cell 40) to provide additional driving range.

In an example, system 10 may be operated in a dispensing mode when tractor 20 and trailer 30 are stationary and electrical power is not supplied to the electric power train (e.g., power train 45) of tractor 20. Fuel cell power (e.g., from fuel cell 40) may instead be coupled via an inverter to electrically powered portions of trailer 20, such as fuel transport device 70 (e.g., a gas compressor or a liquid pump). Such a fuel transport device may force hydrogen from storage vessel 60, through dispenser 90, and into a destination hydrogen fuel tank of an external device or vehicle (e.g., an industrial fuel cell vehicle, port vehicle, fleet vehicle), compliant with SAE fueling standards.

System 10 may advantageously be fully self-contained and operate without being connected to any outside utility connection, i.e., without being connected to other sources of electricity or hydrogen, thereby mimicking an operation of mobile diesel tanker trucks that are widely used in port operations today. Such a system would thus maintain the status quo of operational procedures in such ports and thereby allow adoption of zero emission vehicular technology (e.g., fuel cell electric vehicles) in these ports.

In an example, hydrogen may be delivered and dispensed to industrial fuel cell vehicles. A trailer (trailer 30) with a full tank (e.g., vessel 60 of trailer 30) of hydrogen may be located on a designated transfer location on or near to a property line of an operator of hydrogen vehicles. Such a designated location may be selected with approval of all local authorities and compliant with local union shop rules. Operator personnel may attach a tractor vehicle of their choosing (e.g., after tractor 20 has delivered trailer 30 to the site and been disconnected therefrom) to the trailer (e.g., trailer 30), transport the trailer onto the operator property, and perform refueling operations as needed. Alternatively, tractor 20 and trailer 30 may be located on the property of the operator and refueling operations may be performed therefrom.

An operation of dispensing fuel from a tanker (e.g., vessel 60 of trailer 30) may be very similar to an experience at public fueling stations. When the tanker is empty and requires replenishment, the operator of the facility may deliver the tanker to a designated transfer location where the empty tanker may be connected to a trailer (e.g., trailer 20) and returned to be refilled with hydrogen. In the meantime, a second tanker (e.g., another instance of trailer 30 having vessel 60) may be provided and operated as described above. Such a method of substituting mobile tankers (e.g., instances of vessel 60 of trailer 30) for each other may eliminate a need for a costly fixed hydrogen refilling station with permitting by a local agency having jurisdiction.

In an example, trailer 30 may be a standard size 40 foot long trailer that meets all federal and state road standards without needing an oversized load or other additional permits. Trailer 30 may include on-board hydrogen storage cylinders (e.g., vessel 60) to contain enough useable gas to dispense 320 kG of H2 into port cargo handling vehicles, locomotives, and harbor craft, for example. Trailer 30 may also include valving & tubing manifold to cascade a fueling from the hydrogen cylinders (e.g., of vessel 60) in order to maximize the useable fuel on-board. An automated hydrogen dispensing unit may communicate with the vehicle to be filled (e.g., an industrial fuel cell electric vehicle, port cargo handling vehicles, buses, fleet vehicles, locomotives, and harbor craft) to determine appropriate fill parameters.

Trailer 30 may further include controls & telemetry equipment needed to operate the dispensing & cascade features, as well as allow an operator to record and observe relevant data while fueling. A trailer mounted stationary hydrogen fuel cell power source may also be provided to provide power for the dispensing and telemetry equipment. In an example, a fuel cell power source (e.g., fuel cell 40) in tractor 20 may be connected to power consuming devices (e.g., fuel transport device 70, controller 80 and dispenser 90) of trailer 30 when tractor 20 remains connected to trailer 30.

While several aspects of the present invention have been described and depicted herein, alternative aspects may be effected by those skilled in the art to accomplish the same objectives. Accordingly, it is intended to cover all such alternative aspects as fall within the true spirit and scope of the invention.

We claim:

1. A mobile hydrogen fueling system, comprising:
a towing vehicle comprising a fuel cell for powering an electric motor of the vehicle to allow movement of the vehicle,
and a trailer towed by the vehicle, said trailer comprising:
a hydrogen storage tank;
a hydrogen fuel transport device;
a dispenser for dispensing hydrogen from the tank to a receiving hydrogen tank;
said dispenser in fluid communication with the hydrogen in the tank via the hydrogen fuel transport device;
a controller for controlling a dispensing of the hydrogen from said tank to said receiving hydrogen tank by controlling said hydrogen fuel transport device coupled to said tank; and
wherein said fuel cell of said towing vehicle is electrically coupled to said hydrogen fuel transport device, said dispenser and said controller to provide electrical current thereto.

2. The mobile hydrogen fueling system of claim 1, wherein said fuel cell is coupled to an inverter capable of providing electricity to the hydrogen storage tank, hydrogen fuel transport device, dispenser, and controller.

3. The mobile hydrogen fueling system of claim 1, wherein said hydrogen storage tank is configured to store liquid gas and hydrogen gas.

4. The mobile hydrogen fueling system of claim 1, wherein said energy towing vehicle further comprises an energy storage device coupled to said fuel cell and an electrical load on said towing vehicle, to allow a balancing of an electrical demand between the towing vehicle and the trailer.

5. The mobile hydrogen fueling system of claim 1, wherein said hydrogen fuel transport device comprises a gas compressor.

6. The mobile hydrogen fueling system of claim 1, wherein said hydrogen fuel transport device comprises a liquid pump.

7. The mobile hydrogen fueling system of claim 1, wherein said trailer comprises hydrogen storage cylinders capable of dispensing a predetermined amount of hydrogen into port cargo handling vehicles, locomotives, and/or harbor craft.

8. The mobile hydrogen fueling system of claim 7, wherein said predetermined amount of hydrogen is 320 kilograms.

9. The mobile hydrogen fueling system of claim 1, wherein said hydrogen fuel transport device is configured to provide high pressure fueling up to 700 Ba.

10. The mobile hydrogen fueling system of claim 1, wherein said hydrogen fuel transport device is configured to provide high pressure fueling up to 350 Ba.

11. The mobile hydrogen fueling system of claim 1, wherein said hydrogen storage tank is configured to hold up to 6,000 gallons.

12. A method for refueling hydrogen vehicles comprising:
connecting a trailer having a hydrogen storage tank filled with hydrogen to a towing vehicle;
the towing vehicle transporting the trailer to a location for refueling hydrogen vehicles;
dispensing hydrogen from the container to a receiving container of a hydrogen powered vehicle; and
wherein the trailer and the towing vehicle are unconnected to external sources of power and hydrogen during a dispensing of hydrogen to the vehicle.

13. The method of claim 12 wherein the trailer further comprises:
a hydrogen fuel transport device;
a dispenser for dispensing hydrogen from the storage tank to a receiving hydrogen tank of a hydrogen powered vehicle;
the dispenser in fluid communication with the hydrogen in the storage tank via the hydrogen fuel transport device;
a controller for controlling a dispensing of the hydrogen from the storage tank to the receiving hydrogen tank by controlling the hydrogen fuel transport device coupled to the tank.

14. The method of claim 13 wherein the towing vehicle comprises a fuel cell for powering an electric motor of the vehicle to cause movement of the vehicle.

15. The method of claim 14 wherein the fuel cell of said towing vehicle is electrically coupled to said hydrogen fuel transport device, the dispenser, and the controller to provide electrical current thereto to allow the dispensing.

16. The method of claim 12 further comprising locating a second trailer having a second storage tank filled with hydrogen at a designated transfer location near the location for refueling hydrogen vehicles.

17. The method of claim 16 further comprising transporting the trailer to the designated transfer location by the towing vehicle, disconnecting the trailer from the towing vehicle, connecting the second trailer to the towing vehicle, and transporting the second trailer by the towing vehicle to the location for refueling hydrogen vehicles.

18. The method of claim 12 wherein said hydrogen storage tank is configured to store liquid gas and hydrogen gas.
